(19) United States
(12) Patent Application Publication
(10) Pub. No.: US 2019/0334862 A1
(43) Pub. Date: Oct. 31, 2019

(54) Seamless Network Characteristics For Hardware Isolated Virtualized Environments

(71) Applicant: Microsoft Technology Licensing, LLC, Redmond, WA (US)

(72) Inventors: Anirban Paul, Redmond, WA (US); Poornananda Gaddehosur Ramachandra, Redmond, WA (US); Gerardo Diaz-Cuellar, Kirkland, WA (US); Osman Nuri Ertugay, Bellevue, WA (US); Keith Edgar Horton, North Bend, WA (US); Omar Cardona, Bellevue, WA (US); Nicholas David Wood, Woodinville, WA (US); Shankar Seal, Bothell, WA (US); Dinesh Kumar Govindasamy, Redmond, WA (US)

(21) Appl. No.: 15/965,825

(22) Filed: Apr. 27, 2018

(51) Int. Cl. H04L 29/12; H04L 12/46; G06F 9/455

(52) U.S. Cl. CPC H04L 61/256; H04L 61/2007; G06F 2009/45595; G06F 9/45558; G06F 2009/45587; H04L 12/4641

(57) ABSTRACT

Embodiments described herein relate to providing hardware isolated virtualized environments (HIVEs) with network information. The HIVEs are managed by a hypervisor that virtualizes access to one or more physical network interface cards (NICs) of the host. Each HIVE has a virtual NIC backed by the physical NIC. Network traffic of the HIVEs flows through the physical NIC to a physical network. Traits of the physical NIC may be projected to the virtual NICs. For example, a media-type property of the virtual NICs (exposed to guest software in the HIVEs) may be set to mirror the media type of the physical NIC. A private subnet connects the virtual NICs with the physical NICs, possibly through a network address translation (NAT) component and virtual NICs of the host.

### BACKGROUND

Hardware-isolated virtualization environments (HIVEs) have seen increasing use for reasons such as security, administrative convenience, portability, maximizing utilization of hardware assets, and others. HIVEs are provided by virtualization environments or virtualization layers such as type-1 and type-2 hypervisors, kernel-based virtualization modules, etc. Examples of HIVEs include virtual machines (VMs) and containers. However, the distinction between types of HIVEs have blurred and there are many architectures for providing isolated access to virtualized hardware. For convenience, the term “hypervisor” will be used herein to refer to any architecture or virtualization model that virtualizes hardware access for HIVEs such as VMs and containers. Virtual machine managers (VMMs), container engines, and kernel-based virtualization modules, are some examples of hypervisors.

Most hypervisors provide their HIVEs with virtualized access to the networking resources of the host on which they execute. Guest software executing in a HIVE is presented with a virtual network interface card (vNIC). The vNIC is backed by a physical NIC (pNIC). The virtualization models implemented by prior hypervisors have used a bifurcated network stack state where there is one network stack and state in the HIVE, and a separate network stack and state on the host. The host network hardware, stack, and state are fully opaque to the guest software in a HIVE. The primary network functionality the guest software has had has been external connectivity. The networking hardware and software components that are involved in that providing connectivity for the HIVE have been hidden from the HIVE and its guest software. Moreover, much of the information about the external network that is available at the host is unavailable in the HIVE. In sum, previous hypervisors have not provided the fidelity and network visibility that many applications require to perform their full functionality from within a HIVE. As observed only by the inventors and explained below, this opacity can affect the network performance, security and policy behavior, cost implications, and network functionality of many types of applications when they run in a HIVE.

Regarding network performance, because prior virtualization models have provided mainly network connectivity, the networking information needed for many applications to perform in a network-cognizant manner has not been available when executing within a HIVE. Telecommunication applications for video or voice calls are usually designed to query for network interfaces and their properties and may adjust their behavior differently based on the presence or absence of a media type (e.g. a WiFi (Wireless Fidelity) or mobile broadband NIC). For these types of applications to be able to perform their full functionality, the HIVE would need a representation of all the media types that are present on the host. Many applications will adjust their behavior and may display additional user interface information if they detect that their network traffic is being routed over a costed network (i.e., when data usage fees may apply). Some applications may be configured to look specifically for cellular interfaces because they have code that invokes system-provided interfaces which expose a cost flag to hard-code different policies for connections over a cellular media type. Some synchronization engines and background transfer engines of operating systems may specifically look to the available media type to determine what type of updates to download, when and how much bandwidth to consume, and so forth. In addition, in many cases hiding the host stack from the HIVE implies more layers of indirection and an increased data path, which degrades performance.

With respect to the security and policy behavior of guest software or applications running within a HIVE, some applications have specific requirements to use free-cost interfaces or may need to use a specific Mobile Operator (MO) interface. However, cost is usually exposed at the interface granularity, so if only a single generic interface is exposed in a HIVE then one of these two types of apps will be broken at any given time. Consider that VPNs may support split tunnels where, per policy, some traffic must be routed over a VPN interface, and some traffic may need to be routed over a non-VPN interface. Without sufficient interface information within a HIVE, the software cannot implement the policy. There may be policies that force specific applications to bind to VPN interfaces. If there is only a single interface in the container, an application will not know where to bind, and, if it binds to the single interface inside the container, it won't have enough information to bind again to the VPN interface in the host. Moreover, the HIVE may also be running applications that do not use the VPN and hence the VPN cannot just be specifically excluded from the container. Another security consideration is that for host interfaces that applications running in a HIVE should not use, it is possible to simply not connect them to the HIVE so the interface simply does not exist for the HIVE.

Another consideration is that a guest operating system may have a connection manager with policies to direct traffic over on-demand cellular interfaces, for instance. These interfaces might not even exist before a request is received by the connection manager, which may add a reference or create an interface. A connection manager might also include an application programming interface (API) which can be used by applications. However, functions of the API might have media-specific parameters or filters which cannot be used by guest software without knowing about the available interfaces. To make full use of a connection manager's API, the HIVE would need to know what interfaces are connected to return the appropriate interface/IP (Internet Protocol) to use, which has not previously been possible.

Applications traffic is not the only traffic that may be affected by network opacity within a HIVE. A significant portion of the traffic in a HIVE can be generated by system components on behalf of applications. For example, a DNS (Domain Name Service) system service may send DNS queries on all interfaces. Each interface can potentially receive a different answer and applications may need to see these differences. This is typical in multi-home scenarios. However, if a HIVE has only a single interface then the DNS service will send one single query and only return one specific answer and fail to give the correct responses. The same problem occurs with Dynamic Host Configuration Protocol services.

Regarding network functionality, many applications embed port or IP addresses in their packets, which break when traversing the Network Address Translation (NAT) found in many virtualization stacks. Because virtualization models use NAT artificially, these applications cannot function properly. Moreover, NAT-ing causes applications to increase load in critical enterprise gateway infrastructure. Many applications fall back to NAT traversal technologies using an Internet rendezvous server when peer-to-peer NAT does not work. When NAT is in between, peer-to-peer connectivity fails. When a NAT point is traversed, the NAT point identifying the device is often an external corporate NAT. This can increase the load on the corporation's NAT device.

Furthermore, many virtualization models have an internal network, which can cause IP address conflicts. If the virtualization component uses a complete internal network behind a NAT service inside the host then IP address assignment usually must comply with IPV4. Hence, there is a risk of IP address conflicts with the on-link network. Many applications need to see the on-link network to work properly, for instance to perform discovery. But when a complete internal network is used inside the host, the on-link network can't be seen, which can impact the ability to multicast and broadcast. Consequently, devices cannot be discovered on the network. This may make it impossible to use IP cameras, network-attached storage, networked appliances, and other IP devices. Also, by the time traffic arrives at the host stack, application ID, slots and other information that is relevant for these client features is already missing.

There are other network functionalities that can be impaired when running within a HIVE. Wake-on-LAN functionality, low power modes, and roaming support, for example. Network statistics within the HIVE may poorly reflect the networking reality beyond the HIVE.

The preceding problems, appreciated only by the inventors, are potentially resolved by embodiments described below.

To summarize, with prior hypervisors and virtualization models, the artificial network that a HIVE sees has significantly different characteristics than the real networks that the host sees. Therefore, features coded in a guest operating system or application that depend on the characteristics of the network are likely to malfunction or break, which affects the experience and expectations of users.

### SUMMARY

The following summary is included only to introduce some concepts discussed in the Detailed Description below. This summary is not comprehensive and is not intended to delineate the scope of the claimed subject matter, which is set forth by the claims presented at the end.

Embodiments described herein relate to providing hardware isolated virtualized environments (HIVEs) with network information. The HIVEs are managed by a hypervisor that virtualizes access to one or more physical network interface cards (NICs) of the host. Each HIVE has a virtual NIC backed by the physical NIC. Network traffic of the HIVEs flows through the physical NIC to a physical network. Traits of the physical NIC may be projected to the virtual NICs. For example, a media-type property of the virtual NICs (exposed to guest software in the HIVEs) may be set to mirror the media type of the physical NIC. A private subnet connects the virtual NICs with the physical NICs, possibly through a network address translation (NAT) component and virtual NICs of the host.

Many of the attendant features will be explained below with reference to the following detailed description considered in connection with the accompanying drawings.

### BRIEF DESCRIPTION OF THE DRAWINGS

The present description will be better understood from the following detailed description read in light of the accompanying drawings, wherein like reference numerals are used to designate like parts in the accompanying description.

FIG. 1 shows a prior virtualization networking architecture.

FIG. 2 shows an embodiment where network components of the HIVEs have vmNICs configured to mirror properties of the pNICs of a host.

FIG. 3 shows a process for mirroring pNIC properties to vmNIC properties when a HIVE is being configured.

FIG. 4 shows a process for mirroring pNIC properties to vmNICs during execution of a HIVE.

FIG. 5 shows details of a computing device on which embodiments described above may be implemented.

### DETAILED DESCRIPTION

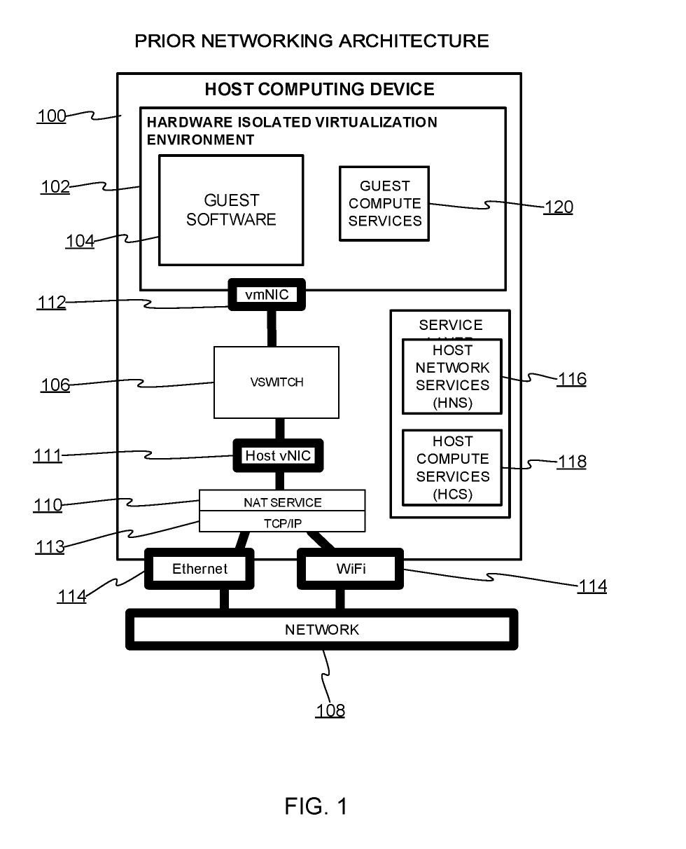

FIG. 1 shows a prior virtualization networking architecture where host 100 and HIVE 102 network bifurcation creates network opacity for guest software 104 running in the HIVE. The example shown in FIG. 1 is not representative of all virtualization networking designs but does provide a backdrop for many of the problems mentioned in the Background that prior network virtualization designs may have.

In the example architecture shown in FIG. 1, a privately numbered virtual IP subnet is provided for the HIVE 102 by the virtual switch (vSwitch) 106. This private subnet is connected to the external network 108 via a NAT service 110, a host vNIC 111, and through the host TCP/IP stack 113. Connectivity for the guest software 104 is provided using a single vmNIC 112 inside the HIVE 102. On the host 100, the NAT service 110 NATs the network traffic to one of the pNICs 114 as determined according to the host's routing table. The NAT service 110 operates behind the TCP/IP stack 113 of the host and translates between external addresses routable on the network 108 and the private subnet of the vSwitch 106. Depending on the implementation, the HIVE may have a service layer with various components to facilitate networking such as a host networking services (HNS) 116 and a host compute services (HCS) 118. The service layer may interact with guest compute services (GCS) 120 installed in the HIVE 102. Together, the service layer and GCS 120 help setup and configure the virtual networking components needed for the HIVE 102.

The vmNIC 112 is a generic virtual device that only attaches to the virtual subnet and is addressed accordingly. From the perspective of the guest software 104, the vmNIC 112 is completely synthetic. Its properties are not determined by any of the properties of the pNICs 114. If a pNIC is removed, the vmMIC 112 might not change. If a pNIC is replaced with a new pNIC of a different media type, the vmNIC 112 is unaffected and the networking behavior and state of the HIVE and guest software will not change (although performance may be affected). Within the HIVE, at the IP layer and at the application layer, the network is generally a virtual construct that, aside from connectivity and performance, does not reflect properties of the network 108, the pNICs 114, and other non-virtualized elements that enable the connectivity for the HIVE.

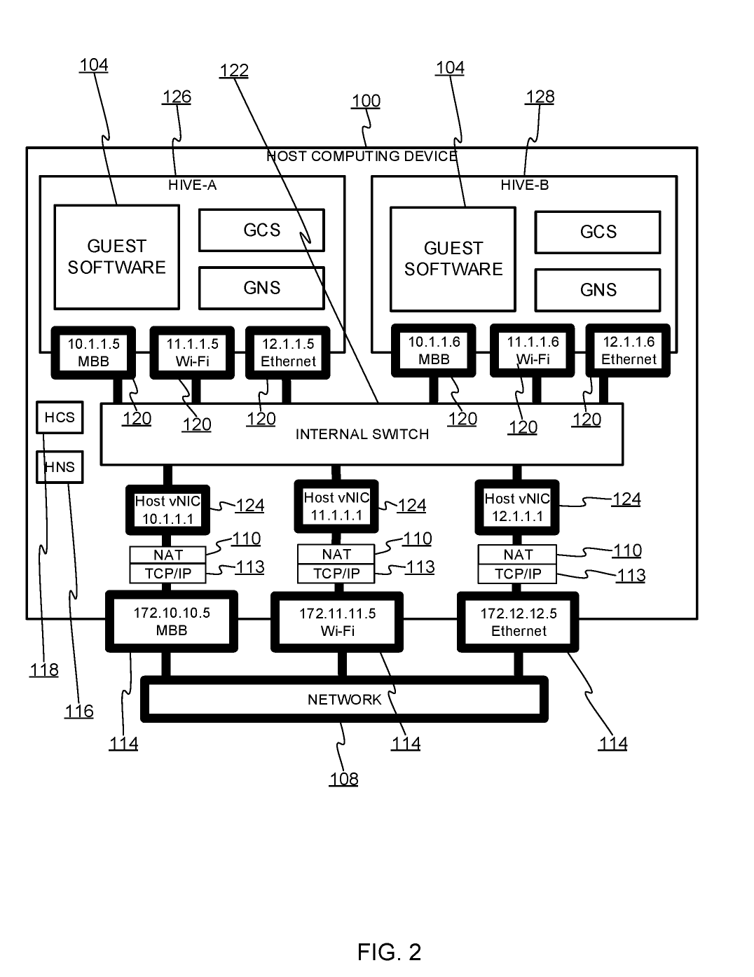

FIG. 2 shows an embodiment where network components of the HIVEs have vmNICs 120 configured to mirror properties of the pNICs 114 of the host 100. For this network virtualization architecture, one internal vSwitch 122 is created with its own separate virtual subnet. A corresponding host vNIC 124 is created for each of the pNICs 114 on the host 100. A NAT 110 component is created between each host vNIC 124 and its respective external pNIC 114. Multiple vmNICs 120 are then assigned to each HIVE, with each vmNIC 120 of a HIVE representing a respective pNIC 114 of the host 100 (not all pNICs need to be represented). A vmNIC at least partly reflects one or more properties of its corresponding pNIC, although, as described below, it does not have to emulate its pNIC's behavior. In the architecture, the IP addresses which are assigned to the vmNICs 120 will be different than the pNIC IP addresses. In the example of FIG. 2, HIVE-A 126 is provided with three vmNICs 120, one for each of the MBB (mobile broadband), WiFi, and Ethernet pNICs 114. HIVE-B 128 is similarly configured.

The vmNICs 120 need not actually emulate or behave in any ways that depend on the pNICs that they correspond to. Furthermore, the design shown in FIG. 2 may not require any media-type-specific stack drivers or services, cellular drivers or services etc. in the HIVE. In addition, the design allows the network-sensitive code of applications to work correctly without modification; such code will automatically become effective in the presence of the exposed pNIC-mirroring properties of the vmNICs. As the guest software 104 queries for NIC properties, it receives property values that reflect the properties of the corresponding pNIC(s). The vmNICs that are provided to the HIVEs by the hypervisor don't have to function like the pNICs that they mirror. For instance, a vmNIC backed by a WiFi NIC does not need to function as a WiFi NIC, even if it is reported as being a WiFi NIC. In addition, layer-2 of the service stack all the way down to the vmNIC does not have to emulate or behave like the pNIC that backs it. The vmNICs that are exposed as WiFi and Cellular vmNICs, for example, can function as an Ethernet NIC (as far as the stack is concerned). As long as the guest software or applications “see” the relevant vmNIC properties as WiFi and cellular devices they will be able to behave accordingly. Even if a vmNIC functions as an Ethernet NIC (e.g., transmitting/receiving Ethernet frames, Ethernet driver, etc.), its traffic as it traverses the host and network 108 will, where it matters, be treated as expected by the application. Where the path of the vmNIC's packets passes to the pNIC and the network 108, the packets will behave and encounter conditions as expected by the guest software. In brief, it is acceptable to spoof the media type of a vmNIC so long as the spoofed media type is handled as the correct media type where cost, performance, policy compliance, and other factors are determined.

To reiterate, in some embodiments, the vmNICs in the HIVEs will advertise the same media type and physical media type as the “parent” pNIC in the host they are associated with. As noted, these vmNICs may actually send and receive Ethernet frames. Layer-2 and/or layer-3 notifications and route changes are propagated from each pNIC on the host, through the vNICs 124 and vSwitch 122 to the corresponding vmNICs inside the HIVEs, where they are visible to the guest software. Client or guest operating system APIs (as the case may be) for networking may be made virtualization-aware so that any calls made to modify WiFi or cellular state, for example, can gracefully fail and provide valid returns, and any calls to read WiFi or cellular vmNIC state, for instance, will correctly reflect the state that exists on the host side.

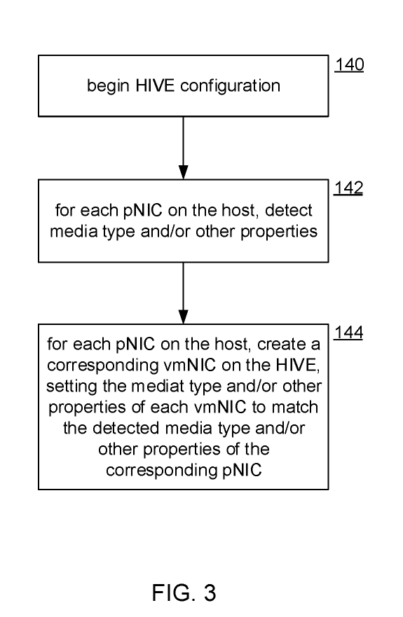

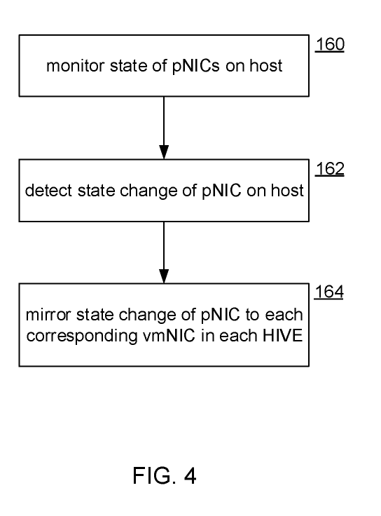

Mirroring pNIC properties to vmNIC properties may occur when configuring a HIVE or when a HIVE is operating. FIG. 3 shows a process for mirroring pNIC properties to vmNIC properties when a HIVE is being configured. The same process may be used when a network change event happens or when a new NIC is created on the host. At step 140 HIVE configuration is initiated. This may occur when a HIVE is instantiated, started, experiences a particular state change, etc. At step 142, for each pNIC on the host, the media type and/or other NIC properties are detected by the hypervisor. At step 144, for each pNIC on the host, a corresponding vmNIC is created and its media type or other properties are set according the properties discovered at step 142. FIG. 4 shows a process for mirroring pNIC properties to vmNICs during execution of a HIVE. At step 160, state of the pNIC is monitored. At step 162 a change in state (or properties) of the pNIC corresponding to vmNIC(s) is detected. Any properties of the pNIC backing vmNIC(s) is mirrored to the vmNIC(s) in each HIVE. In sum, the hypervisor assures that the vmNICs reflect their pNICs even as things on the host side change.

Properties that may be projected from pNICs to vmNICs may also include wake slots and others. In some embodiments, the same IP address, same MAC address, network routes, WiFi signal strength, broadcast domain, subnet, etc. may be projected to a HIVE, but into a separate kernel (if the HIVE hosts a guest operating system). As noted above, host mirroring logic may also include mirroring the addition of a new pNIC on the host. In that case, a new vmNIC is added to the HIVE (or HIVEs), with one or more properties reflecting properties of the new pNIC.

To be clear, the techniques described above differ from single root input/output virtualization (SR-IOV), which does not provide information in a way that allows an application to understand the information and tune its performance in a network cognizant manner.

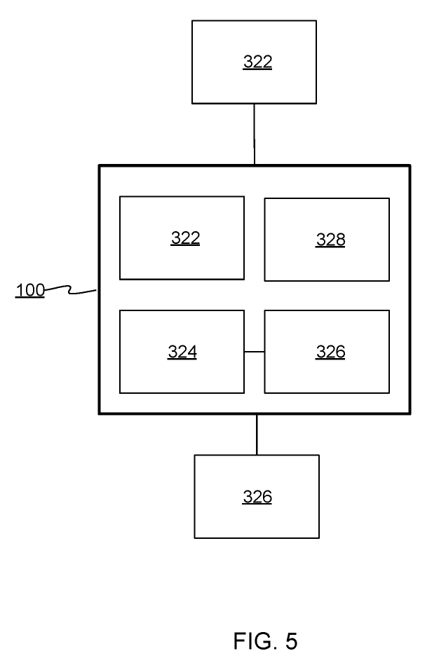

FIG. 5 shows details of the computing device 100 on which embodiments described above may be implemented. The technical disclosures herein will suffice for programmers to write software, and/or configure reconfigurable processing hardware (e.g., field-programmable gate arrays (FPGAs)), and/or design application-specific integrated circuits (ASICs), etc., to run on the computing device 100 (possibly via cloud APIs) to implement the embodiments described herein.

The computing device 100 may have one or more displays 322, a camera (not shown), a network interface 324 (or several), as well as storage hardware 326 and processing hardware 328, which may be a combination of any one or more: central processing units, graphics processing units, analog-to-digital converters, bus chips, FPGAs, ASICs, Application-specific Standard Products (ASSPs), or Complex Programmable Logic Devices (CPLDs), etc. The storage hardware 326 may be any combination of magnetic storage, static memory, volatile memory, non-volatile memory, optically or magnetically readable matter, etc. The meaning of the term “storage”, as used herein does not refer to signals or energy per se, but rather refers to physical apparatuses and states of matter. The hardware elements of the computing device 100 may cooperate in ways well understood in the art of machine computing. In addition, input devices may be integrated with or in communication with the computing device 100. The computing device 100 may have any form-factor or may be used in any type of encompassing device. The computing device 100 may be in the form of a handheld device such as a smartphone, a tablet computer, a gaming device, a server, a rack-mounted or backplaned computer-on-a-board, a system-on-a-chip, or others.

Embodiments and features discussed above can be realized in the form of information stored in volatile or non-volatile computer or device readable storage hardware. This is deemed to include at least hardware such as optical storage (e.g., compact-disk read-only memory (CD-ROM)), magnetic media, flash read-only memory (ROM), or any means of storing digital information in to be readily available for the processing hardware 328. The stored information can be in the form of machine executable instructions (e.g., compiled executable binary code), source code, bytecode, or any other information that can be used to enable or configure computing devices to perform the various embodiments discussed above. This is also considered to include at least volatile memory such as random-access memory (RAM) and/or virtual memory storing information such as central processing unit (CPU) instructions during execution of a program carrying out an embodiment, as well as non-volatile media storing information that allows a program or executable to be loaded and executed. The embodiments and features can be performed on any type of computing device, including portable devices, workstations, servers, mobile wireless devices, and so on.

Embodiments and features discussed above can be realized in the form of information stored in volatile or non-volatile computer or device readable media. This is deemed to include at least media such as optical storage (e.g., compact-disk read-only memory (CD-ROM)), magnetic media, flash read-only memory (ROM), or any current or future means of storing digital information. The stored information can be in the form of machine executable instructions (e.g., compiled executable binary code), source code, bytecode, or any other information that can be used to enable or configure computing devices to perform the various embodiments discussed above. This is also deemed to include at least volatile memory such as random-access memory (RAM) and/or virtual memory storing information such as central processing unit (CPU) instructions during execution of a program carrying out an embodiment, as well as non-volatile media storing information that allows a program or executable to be loaded and executed. The embodiments and features can be performed on any type of computing device, including portable devices, workstations, servers, mobile wireless devices, and so on.

1. A computing device comprising:
processing hardware and storage hardware, a first physical network interface card (NIC), and a second physical NIC, wherein the first and second NICs are configured for different respective network media types:
the storage hardware storing a hypervisor configured to provide hardware isolated virtual environments (HIVEs), each HIVE configured to host guest software, the hypervisor providing each HIVE with virtualized access to the processing hardware, the storage hardware, the first physical NIC, and the second physical NIC, wherein each HIVE comprises a first virtual NIC and a second virtual NIC, each first virtual NIC virtualizing access to the first physical NIC, and each second virtual NIC virtualizing access to the second physical NIC, wherein each first virtual NIC exposes a first network media type to the guest software of its corresponding HIVE, wherein each second virtual NIC exposes a second network media type to the guest software of its corresponding HIVE, wherein the exposed first network media type is set for the first virtual NICs based on a network media type of the first physical NIC, and wherein the second exposed media type is set for the second virtual NICs based on a network media type of the second physical NIC.

2. A computing device according to claim 1, wherein guest software in a HIVE that is directed to a corresponding first virtual NIC is transmitted by the first physical NIC and not the second physical NIC, and wherein guest software in the HIVE that is directed to a corresponding second virtual NIC is transmitted by the second physical NIC and not the first physical NIC.

3. A computing device according to claim 1, wherein the hypervisor comprises a privately numbered virtual IP (Internet Protocol) subnet for the HIVEs, and wherein the privately numbered virtual IP subnet is connected to an external network via network address translation (NAT) performed by a network stack of the hypervisor.

4. A computing device according to claim 3, wherein the virtual IP subnet comprises a virtual switch connected to a first host virtual NIC that corresponds to the first physical NIC and a second host virtual NIC that corresponds to the second physical NIC, the host, which is hypervisor-capable, provides NAT between the first physical NIC and the first host virtual NIC, and the hypervisor-capable host provides NAT between the second physical NIC and the second host virtual NIC.

5. A computing device according to claim 1, further comprising providing the first and second virtual NICs with read-only properties that can be read by the guest software, wherein the properties correspond to values of properties of the first and second physical NICs.

6. A computing device according to claim 5, further comprising providing an API, the API including a method for simulating updating of properties of the first and second virtual NICs, wherein when the method is invoked the virtualization layer provides a response without modifying the property.

7. A computing device according to claim 1, wherein the first network media type and the second network media type comprise a wireless media type, Ethernet media type, cellular media type, or a virtual private network (VPN) media type.

8. A computing device comprising:
processing hardware;
storage hardware storing instructions executable by the processing hardware and configured to, when executed by the processing hardware, cause the computing device to perform a process comprising:
executing a hypervisor, the hypervisor providing a HIVE comprised of a virtual NIC backed by a physical NIC that is connected to a physical network, the physical NIC having a media type;
obtaining the media type of the physical NIC;
configuring a media type of the virtual NIC to be the obtained media type; and
exposing the media type of the virtual NIC to guest software executing in the HIVE.

9. A computing device according to claim 8, wherein properties of the physical NIC are mirrored to properties of the virtual NIC.

10. A computing device according to claim 8, wherein the guest software in the HIVE comprises a component that is sensitive to the media type of the virtual NIC, and wherein the component recognizes the virtual NIC as a wireless, Ethernet, or cellular virtual NIC and functions accordingly.

11. A computing device according to claim 10, wherein the virtual NIC is presented as a wireless, Ethernet, or cellular NIC and layer-2 data sent and received by the wireless virtual NIC comprises Ethernet frames.

12. A computing device according to claim 8, the process further comprising propagating layer-2 and/or layer-3 notifications from the physical NIC of the host to the virtual NIC within the HIVE.

13. A computing device according to claim 8, the process further comprising propagating layer-2 and/or layer-3 route changes from the physical NIC to the virtual NIC.

14. A computing device according to claim 8, wherein a networking component running in the HIVE is configured to be virtualization-aware and determines that it is executing in a virtualized environment, and based on determining that it is executing in a virtualized environment: provides valid responses to calls from the guest software that are intended to modify a state or property of the virtual NIC without modifying the state or property.

15. A computing device according to claim 8, wherein the virtual NIC functions as a NIC of one media type with respect to the guest software and functions as a NIC of another media type with respect to the virtualization layer.

16. Storage hardware storing information configured to cause a computing device to perform a process, the process comprising:
executing a hypervisor that manages HIVEs executing on the computing device, each HIVE comprised of respective guest software;
providing first virtual NICs for the HIVEs, respectively, the first virtual NIC of each HIVE exposed to the HIVE's guest software, wherein each of the first virtual NICs is backed by a same physical NIC configured to connect to a non-virtual network; and
determining properties of the physical NIC and setting corresponding properties of the virtual NICs.

17. Storage hardware according to claim 16, wherein the virtual NICs share a same network address space.

18. Storage hardware according to claim 17, the process further comprising providing a virtual subnet connected to the first virtual NICs and to second virtual NICs, each second virtual NIC corresponding to a respective first virtual NIC, wherein the second virtual NICs share the same network address space.

19. Storage hardware according to claim 18, the process further comprising performing NAT between the second virtual NICs and the physical NIC, the NAT translating between the network address space and a network address space of the non-virtual network to which the physical NIC is connected.

20. Storage hardware according to claim 16, the process further comprising automatically adding a new virtual NIC to the HIVE responsive to detecting a new physical NIC on the computing device, wherein one or more properties of the new virtual NIC are set according to corresponding one or more properties of the new physical NIC.
